(19) United States
(12) Patent Application Publication
(10) Pub. No.: US 2026/0311482 A1
(43) Pub. Date: Oct. 8, 2026

(54) AUTOMATED ITEM IMAGE PROCESSING SYSTEM AND METHOD

(71) Applicant: DoorDash, Inc., San Francisco, CA (US)

(72) Inventors: Joel Ruben Antony Moniz, Santa Clara, CA (US); Andrew Kritzer, San Carlos, CA (US); Ying Yang, Cupertino, CA (US); Zheng Hu, Jersey City, NJ (US); Yilin Ren, Kirkland, WA (US); Geunwook Paek, Burlingame, CA (US)

(73) Assignee: DoorDash, Inc., San Francisco, CA (US)

(21) Appl. No.: 19/636,480

(22) Filed: Apr. 1, 2026

Related U.S. Application Data
(60) Provisional application No. 63/782,967, filed on Apr. 3, 2025.

(51) Int. Cl. G06V 10/98; G06T 7/00; G06T 7/12; G06T 11/60; G06V 10/26; G06V 20/68

(52) U.S. Cl. CPC G06V 10/993; G06T 7/0002; G06T 7/12; G06T 11/60; G06V 10/26; G06V 20/68; G06T 2207/10024; G06T 2207/30128; G06T 2207/30168; G06T 2210/22

(57) ABSTRACT

A method includes a computer receiving image data for an image of a food item. The computer identifies at least the food item in the image. The computer separates at least the food item from the image to form a food item image. The computer modifies the food item image if the food item image is determined to be incomplete. The computer creates a candidate image by creating a background for the food item image and then applying the background to the food item image. The computer selects the candidate image. The computer displays the selected candidate image in an application or a website of a service provider computer.

### CROSS-REFERENCES TO RELATED APPLICATIONS

This application claims the benefit of U.S. Provisional Application No. 63/782,967, filed Apr. 3, 2025, which is herein incorporated by reference in its entirety for all purposes.

### SUMMARY

One embodiment includes a method comprising: receiving, by a computer, image data for an image of a food item; identifying, by the computer, at least the food item in the image; separating, by the computer, at least the food item from the image to form a food item image; modifying, by the computer, the food item image if the food item image is determined to be incomplete; creating, by the computer, a candidate image by creating a background for the food item image and then applying the background to the food item image; selecting, by the computer, the candidate image; and displaying, by the computer, the selected candidate image in an application or a website of a service provider computer.

Another embodiment is related to a computer comprising: a processor; and a non-transitory computer readable medium comprising code, executable by the processor for performing a method comprising: receiving image data for an image of a food item; identifying at least the food item in the image; separating at least the food item from the image to form a food item image; modifying the food item image if the food item image is determined to be incomplete; creating a candidate image by creating a background for the food item image and then applying the background to the food item image; selecting the candidate image; and displaying the selected candidate image in an application or a website of a service provider computer.

Another embodiment is related to a system comprising: an image database; an item information database; and an image analysis computer comprising: a processor; and a non-transitory computer readable medium comprising code, executable by the processor for performing a method comprising: receiving image data for an image of a food item from the image database; identifying at least the food item in the image; separating at least the food item from the image to form a food item image; modifying the food item image if the food item image is determined to be incomplete; creating a candidate image by creating a background for the food item image and then applying the background to the food item image; selecting the candidate image; and displaying the selected candidate image in an application or a website of a service provider computer.

### BRIEF DESCRIPTION OF THE DRAWINGS

FIG. 1 shows a block diagram illustrating an image processing system according to some embodiments.

FIG. 2 shows a block diagram illustrating an image analysis computer according to some embodiments.

FIG. 3 shows a hybrid diagram illustrating a method including generating candidate images based on image data for a fulfillment application according to some embodiments.

FIG. 4 shows a diagram illustrating exemplary modifications to images according to some embodiments.

FIG. 5 shows a block diagram illustrating a fulfillment system according to some embodiments.

FIG. 6 shows a block diagram illustrating a fulfillment method according to some embodiments.

### DETAILED DESCRIPTION

Prior to discussing embodiments of the disclosure, some terms can be described in further detail.

A “user” may include an individual or a computational device. In some embodiments, a user may be associated with one or more personal accounts and/or mobile devices. In some embodiments, the user may be a cardholder, account holder, or consumer.

A “user device” may be any suitable electronic device that can process and communicate information to other electronic devices. The user device may include a processor and a computer-readable medium coupled to the processor, the computer-readable medium comprising code, executable by the processor. The user device may also each include an external communication interface for communicating with each other and other entities. Examples of user devices may include a mobile device (e.g., a mobile phone), a laptop or desktop computer, a wearable device (e.g., smartwatch), etc.

An “item” can be an individual article or unit. Examples of items can include perishable items such as food items, beauty items (e.g., cosmetics), office supply products (e.g., staples, paper, and ink), hardware items (e.g., nails, hammers, wrenches), electronic devices (e.g., computers, phones, etc.), jewelry, etc. “Image data” can include information related to a visible impression obtained by a camera, telescope, microscope, or other device, or displayed on a computer or video screen. Image data can include a plurality of pixels, where each pixel can include data that indicates how that pixel is displayed (e.g., a color value, etc.).

A “shelf unit” can include a surfaces upon which items can be displayed. A shelf unit can include horizontal shelves, gondola shelfs, wire rack shelfs, etc. A shelf unit can display a plurality of items and item tags that relate to the items.

A “transporter” can be an entity that transports something. A transporter can be a person that transports an item using a transportation device (e.g., a car). In other embodiments, a transporter can be a transportation device that may or may not be operated by a human. Examples of transportation devices include cars, boats, scooters, bicycles, drones, airplanes, etc. In some embodiments, the user device can be integrated into a transportation device. A transporter can be an autonomous vehicle such as an autonomous car or autonomous drone.

A “fulfillment request” can be a request to provide a resource in response to a request. For example, a fulfillment request can include an initial communication from an end user device to a central server computer for a first service provider computer to fulfill a purchase request for a resource such as food. A fulfillment request can be in an initial state, a completed state, or a final state. A fulfillment request can include one or more selected items that a user wishes to obtain from a selected service provider.

A “delivery order” can include a request to deliver one or more items. Delivery orders can include requests to provide one or more items from a pickup location to a drop-off location. Delivery orders can include orders to deliver items from service provider locations to end user locations. Delivery orders can include orders to deliver items from end user locations to service provider locations. An example of this type of delivery order can be a return order (e.g., to deliver an item that is to be returned). A delivery order can include data to fulfill the delivery request including an order type, an indication of an item, a pickup location, and a drop-off location. In some embodiments, the delivery order can include a scheduling range by which the order is to be fulfilled. A delivery order can also include metadata. The metadata can include data relating to the delivery order (e.g., related order numbers, instruction data, etc.).

A “route” can include a way or course taken in getting from a starting point to a destination. For example, a route can indicate a path that can be followed to move from a pickup location to a drop-off location. In some embodiments, a route can indicate a suggested path that a transporter can follow to deliver an item from a service provider to an end user (or vice-versa) for a delivery order. A route can be a journey between two locations.

A “machine learning model” (ML model) can refer to a software module configured to be run on one or more processors to provide a classification or numerical value of a property of one or more samples. An ML model can include various parameters (e.g., for coefficients, weights, thresholds, functional properties of function, such as activation functions). As examples, an ML model can include at least 10, 100, 1,000, 5,000, 10,000, 50,000, 100,000, or one million parameters. An ML model can be generated using sample data (e.g., training samples) to make predictions on test data. Various number of training samples can be used, e.g., at least 10, 100, 1,000, 5,000, 10,000, 50,000, 100,000, or at least 200,000 training samples. One example is an unsupervised learning model such as hidden Markov model (HMM), clustering (e.g., hierarchical clustering, k-means, mixture models, model-based clustering, density-based spatial clustering of applications with noise (DBSCAN), and OPTICS algorithm), approaches for learning latent variable models such as Expectation-maximization algorithm (EM), method of moments, and blind signal separation techniques (e.g., principal component analysis, independent component analysis, non-negative matrix factorization, singular value decomposition), and anomaly detection (e.g., local outlier factor and isolation forest). Another example type of model is supervised learning that can be used with embodiments of the present disclosure. Example supervised learning models may include different approaches and algorithms including analytical learning, statistical models, artificial neural network (e.g. including convolutional and/or transformer layers) that may have 1-10 layers as examples, recurrent neural network (e.g., long short term memory, LSTM), boosting (meta-algorithm), bootstrap aggregating (bagging) such as random forests, support vector machine (SVM), support vector (SVR), Bayesian statistics, case-based reasoning, decision tree learning, inductive logic programming, linear regression, logistic regression, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), ordinal classification, data pre-processing, handling imbalanced datasets, statistical relational learning, or Proaftn (a multicriteria classification algorithm), or an ensemble of any of these types. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

A “deep neural network (DNN)” may be a neural network in which there are multiple layers between an input and an output. Each layer of the deep neural network may represent a mathematical manipulation used to turn the input into the output. In particular, a “recurrent neural network (RNN)” may be a deep neural network in which data can move forward and backward between layers of the neural network.

A “model database” may include a database that can store machine learning models. Machine learning models can be stored in a model database in a variety of forms, such as collections of parameters or other values defining the machine learning model. Models in a model database may be stored in association with keywords that communicate some aspect of the model. For example, a model used to evaluate news articles may be stored in a model database in association with the keywords “news,” “propaganda,” and “information.” A computer can access a model database and retrieve models from the model database, modify models in the model database, delete models from the model database, or add new models to the model database.

A “feature vector” may include a set of measurable properties (or “features”) that represent some object or entity. A feature vector can include collections of data represented digitally in an array or vector structure. A feature vector can also include collections of data that can be represented as a mathematical vector, on which vector operations such as the scalar product can be performed. A feature vector can be determined or generated from input data. A feature vector can be used as the input to a machine learning model, such that the machine learning model produces some output or classification. The construction of a feature vector can be accomplished in a variety of ways, based on the nature of the input data. For example, for a machine learning classifier that classifies words as correctly spelled or incorrectly spelled, a feature vector corresponding to a word such as “LOVE” could be represented as the vector (12, 15, 22, 5), corresponding to the alphabetical index of each letter in the input data word. For a more complex “input,” such as a human entity, an exemplary feature vector could include features such as the human's age, height, weight, a quantitative representation of relative happiness, etc. Feature vectors can be represented and stored electronically in a feature store. Further, a feature vector can be normalized (i.e., be made to have unit magnitude). As an example, the feature vector (12, 15, 22, 5) corresponding to “LOVE” could be normalized to approximately (0.40, 0.51, 0.74, 0.17).

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

### I. Introduction

Providing high-quality images for menu items presents a significant technical challenge for service providers. Often, service providers lack the time or the resources to conduct professional photoshoots, which require careful plating and dedicated photography to produce menu-worthy images. An alternative approach involves using images submitted by users. However, user-submitted images frequently suffer from poor quality, such as inadequate lighting, blurriness, or unflattering presentation in takeout containers.

Previous approaches to solving this problem have limitations. One such approach uses generative artificial intelligence to create an image based on the dish's name and description. A drawback of this method can be that the generated image may not accurately represent the actual dish an end user receives, potentially differing in portion size, ingredients, or overall appearance. Another technique involves compositing, where the food from a user's photo can be extracted and placed onto a fixed background. This method can result in visual artifacts, perspective mismatches between the food and the background, and semantic inconsistencies, such as placing a soup on a plate.

Embodiments of the invention can solve such technical problems by converting low-quality, user-submitted images into high-quality, menu-worthy photographs while ensuring the final image remains an authentic and appealing representation of the food item. The architecture can convert unappealing food-related photographs into appetizing images using a modular solution, for example, a system in which the various components can be swapped out for one another easily as required. This approach can ensure that the final image generated can be close to the actual dish the user receives with respect to several parameters, including portion, quantity, garnishes, ingredients, and other edible components. In addition, the food in the final image can match the perspective of the background dish, and the final image can be semantically coherent and free from visual artifacts. The final image can appear natural and can authentically represent the food the user received, and furthermore, can be of menu-quality, appearing as if the food has been carefully plated and photographed in a professional setting.

The process can include several steps to achieve this transformation. Initially, image enhancement and correction can be performed, where various artifacts and issues with the image can be corrected by running processes such as color correction, deblurring, denoising, and relighting. Subsequently, object detection and semantic segmentation can be used to extract the food from the user-provided image. If multiple food items are present in a single image, each item can be processed separately. If the food appears partially eaten or cropped, an in-filling process can be applied to complete the food item. A visual understanding step can then be performed, which can involve analyzing various properties related to the food in question to better inform subsequent steps about how best to plate the food. For example, the shape and color of the original takeout container can be identified, along with the kind of utensil that would be used with the food. This information can be used to create a set of prompts that describe the utensil and an accompanying background that might best fit the food and utensil combination. These prompts can also factor in other service provider-related customizations, using information from the service provider's own description or sample photos from their menu.

Following the visual understanding step, a conditional background generation process can create the entire image based on the generated prompt, which specifies what the background plating should look like, as well as utilizing the food item image in the foreground. In some embodiments, the visual understanding step can also include a classifier that pre-emptively classifies an image and its segmentation into one of a few categories. For instance, an image can be classified as “unrescuable” if the segmentation is incorrect or the image quality is too poor. Alternatively, the system can, with high confidence, predict an optimal service to use for background completion, as certain models may be better for specific types of images based on low-level details like lighting or high-level details like the type of dish. If the system is uncertain, then the system can elect to try all available services or models. This classification system can be learned in a data-driven way, using human preferences from moderator responses, an AI-as-a-judge model, and/or end-user preferences. Finally, the generated image can be validated by a combination of automatic and human agents. This validation can ensure the image correctly represents the food, does not add or omit any components from the original image, does not contain hallucinations or unnatural artifacts, and generally meets the quality standards for a menu image. This step can involve selecting the best candidate from a series of generated images.

### II. Exemplary Image Processing Systems

Embodiments provide for image processing systems that can facilitate the transformation and enhancement of image data in connection with menu items or other objects of interest. This section outlines system architectures that can be utilized to receive, analyze, and process image data.

### A. Analysis System Overview

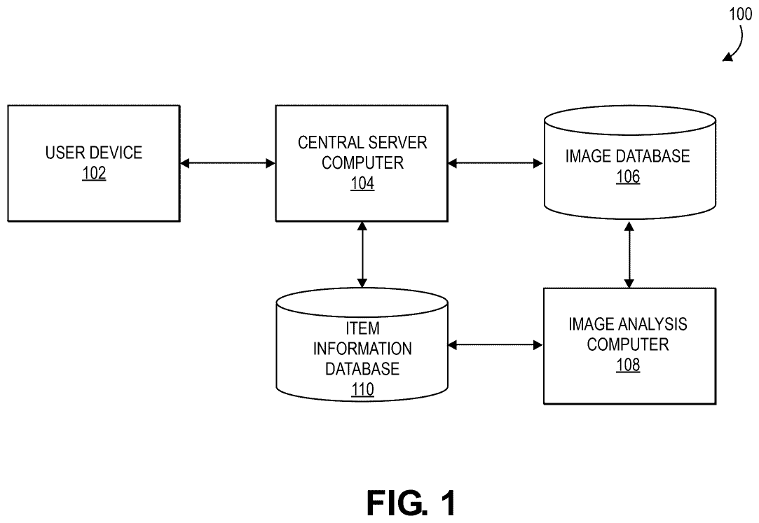

FIG. 1 shows an analysis system 100 according to embodiments of the disclosure. The analysis system 100 comprises a central server computer 102, a user device 104, an image database 106, an image analysis computer 108, and an item information database 110.

The user device 104 can be in operative communication with the central server computer 102. The central server computer 102 can be in operative communication with the image database 106 and the item information database 110. The image analysis computer 108 can be in operative communication with the image database 106 and the item information database 110.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1.

The central server computer 102 can include a server computer that can communicate with a plurality of user devices to obtain image data. The central server computer 102 can store received image data into the image database 106.

In some embodiments, the central server computer 102 can aid in processing fulfillment requests to provide resources from service providers to end users via transporters. The central server computer 102 can maintain and update item listings that can be accessible on a delivery application managed by the central server computer 102. The delivery application can be installed on end user devices and can allow end users to select items from the item listings to have delivered to the end user from a service provider location by a transporter. The central server computer 102 can update item listings based on item information data entries in the item information database 110.

In some embodiments, the central server computer 102 can maintain and update item listings on the delivery application using data from the item information database 110 as well as inventory information provided from the service provider computer 122.

The user device 104 can include an end user device or a transporter user device operated by a user, or some other device such as a client device operated by an entity such as a resource provider and inventor manager. The user device 104 can include a device such as a smartphone, a wearable device, a laptop computer, etc. The user device 104 can include a camera that can capture image data of an image. The user device 104 can provide image data for one or more images to the central server computer 102.

In some embodiments, the user device 104 can be operated by a transporter during a fulfillment request (e.g., a delivery) of an item from a service provider location to an end user, or at some other time. The transporter can be prompted by the user device 104 to capture image data using the user device 104 of an item at the service provider location. The user device 104 can include a camera capable of capturing image data. After obtaining the image data, the user device 104 can provide the image data to the central server computer 102. The user device 104 can also provide additional data related to the image data to the central server computer 102. For example, the user device 104 can provide a service provider location, a service provider identifier, a service provider location identifier, user device orientation data, image metadata, and/or other data related to the service provider location, and/or user device 104.

In other embodiments, the user device 104 can be operated by an end user. The end user can use the user device 104 to capture an image of one or more items (e.g., food items) that were delivered to the end user by a transporter.

In some embodiments, the analysis system 100 can include a plurality of user devices that are in communication with the central server computer 102. Each user device of the plurality of user devices can provide additional image data to the central server computer 102.

The image database 106 can store image data. The image database 106 can store information that relates the image data other data. For example, the image database 106 can store the image data in association with the service provider location, the service provider identifier, the service provider location identifier, the aisle number, user device orientation data, the image metadata, and/or other data.

The image analysis computer 108 can include computer that is configured or programmed to process image data. The image analysis computer 108 can be a laptop computer, a desktop computer, a server computer, etc. The image analysis computer 108 can obtain image data from the image database 106. The image analysis computer 108 can receive image data of an image of a shelf unit with items. The image analysis computer 108 can analyze the image data.

In some embodiments, after processing the image data, the image analysis computer 108 can generate an item information data entry that indicates information about one or more items identified in the image data. The image analysis computer 108 can store the item information data entry into the item information database 110. For example, the item information data entry can include an selected candidate image of the item.

The item information database 110 can store item information data entries for items that are provided by service providers to end users via transporters. The item information database 110 can store information that can indicate information related to an item, such as an image, a title, a description, a cuisine type, etc.

The image database 106 and the item information database 110 can include any suitable databases. The databases may be a conventional, fault tolerant, relational, scalable, secure database such as those commercially available from Oracle™ or Sybase™.

### B. Image Analysis Computer

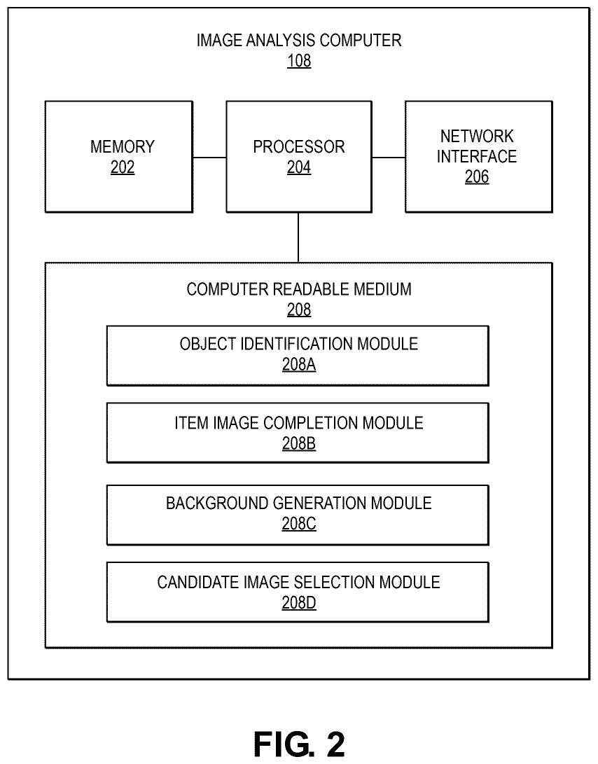

FIG. 2 shows a block diagram of the image analysis computer 108 according to embodiments. The exemplary image analysis computer 108 may comprise a processor 204. The processor 204 may be coupled to a memory 202, a network interface 206, and a computer readable medium 208. The computer readable medium 208 can comprise an object identification module 208A, an item image completion module 208B, a background generation module 208C, and a candidate image selection module 208D.

The memory 202 can be used to store data and code. For example, the memory 202 can store images, image data, fulfilment data, item data, machine learning models, machine learning model weights, identifiers, etc. The memory 202 may be coupled to the processor 204 internally or externally (e.g., cloud based data storage), and may comprise any combination of volatile and/or non-volatile memory, such as RAM, DRAM, ROM, flash, or any other suitable memory device.

The computer readable medium 208 may comprise code, executable by the processor 204, for performing a method comprising: receiving, by a computer, image data for an image of a food item; identifying, by the computer, at least the food item in the image; separating, by the computer, at least the food item from the image to form a food item image; modifying, by the computer, the food item image if the food item image is determined to be incomplete; creating, by the computer, a candidate image by creating a background for the food item image and then applying the background to the food item image; selecting, by the computer, the candidate image; and displaying, by the computer, the selected candidate image in an application or a website of a service provider computer.

The object identification module 208A may comprise code or software, executable by the processor 204, for identifying objects in images. The object identification module 208A, in conjunction with the processor 204, can identify items in images. For example, the object identification module 208A, in conjunction with the processor 204, can identify food in an image. The object identification module 208A, in conjunction with the processor 204, can also identify a plurality of items in an image if more than one item is present in the image. The object identification module 208A, in conjunction with the processor 204, can perform object detection and classification to identify an item in an image.

The object identification module 208A, in conjunction with the processor 204, can identify objects in image data using a machine learning model. The object identification module 208A, in conjunction with the processor 204, can train, maintain, and/or utilize a computer vision (CV) machine learning model to identify objects in images. The computer vision machine learning model can be designed to evaluate visual data based on features and contextual information identified during training of the computer vision machine learning model. This training can allow the computer vision machine learning model to interpret images as well as video (e.g., which can be a sequence of images) and apply those interpretations to predictive or decision making tasks.

The computer vision machine learning model can be a convolutional neural network. Convolutional neural networks can be neural networks with a multi-layered architecture that are used to gradually reduce data and calculations to the most relevant set. This most relevant set is then compared against known data (e.g., such as a label) to identify or classify the data input.

When an image is processed by the computer vision machine learning model, each base color used in the image (e.g., red, green, and blue) can represented as a matrix of values. These values are evaluated and condensed into tensors (e.g., a 3 dimensional grid of values in the case of color images), which can be collections of stacks of feature maps tied to a section of the image. These tensors can be created by passing the image through a series of convolutional layers and pooling layers, which are used to extract the most relevant data from an image segment and condense it into a smaller, representative matrix. This process can be repeated numerous times, which can depend on the number of convolutional layers in the architecture. The final features extracted by the convolutional process are sent to a fully connected layer, which can generate predictions.

Computer vision techniques can utilize two different types of object detection: two-step object detection and one-step object detection.

For two-step object detection, the first step can utilize a region proposal network (RPN), which can provide a number of candidate regions that may contain important objects in the image data. The second step can include passing region proposals to a neural classification architecture, commonly a region-based convolutional neural network (RCNN) based hierarchical grouping algorithm, or region of interest (ROI) pooling in a fast RCNN. These approaches are provided for the tradeoff of increased accuracy, but decreased speed.

One-step object detection can be utilized for faster and/or real-time object detection. One-step object detection architectures can process image data faster than two-step object detection architectures. One-step object detection architectures can include you only look once (YOLO), single shot multibox detector (SSD), and RetinaNet. The one-step object detection architectures combine the detection and classification steps by regressing bounding box predictions. Each determined bounding box can be represented with a few coordinates, making it easier to combine the detection and classification steps and speed up processing. The computer vision machine learning model can utilize one-step object detection.

As such, the object identification module 208A, in conjunction with the processor 204, can utilize object detection and classification processes such as Mask-RCNN (Mask region-based convolutional neural network), YOLO (you only look once), EVA (explore visual scale), etc.

The item image completion module 208B may comprise code or software, executable by the processor 204, for completing images of items (e.g., item images). The item image completion module 208B, in conjunction with the processor can generate portion(s) of images to complete incomplete items. For example, the item image completion module 208B, in conjunction with the processor 204, can generate a portion of a donut to complete an image of a donut that has a section removed.

The item image completion module 208B, in conjunction with the processor 204, can perform in-filling and/or out-filling to complete the item(s) that are incomplete in the image. The item image completion module 208B, in conjunction with the processor 204, can perform in-filling using generative models to analyze the pixels surrounding an incomplete area within the item and to generate new image data that seamlessly completes the item. The item image completion module 208B, in conjunction with the processor 204, can perform out-filling to extend the boundaries of an item that has been truncated, for example, at the edge of the image. This process can be accomplished by utilizing one or more application programming interfaces (APIs), such as those provided by Claid and Photoroom, to synthesize the missing portions of the item.

In some embodiments, the item image completion module 208B, in conjunction with the processor 204, can utilize a stable diffusion architecture or a variant derived therefrom to aid in item image completion.

The background generation module 208C may comprise code or software, executable by the processor 204, for generating backgrounds for images. The background generation module 208C, in conjunction with the processor 204, can generate a new background for a food item image by creating a text prompt that describes an appealing setting for the food item. The prompt can be generated using a large language model (LLM) and can be based on various inputs, such as the name of the restaurant, a description of the dish, and properties identified during a visual understanding step.

The background generation module 208C, in conjunction with the processor 204, can then perform a text-guided background creation process, where the generated text prompt is used to conditionally generate the missing background, such as a serving dish or utensil, for the segmented food item. The background generation module 208C, in conjunction with the processor 204, can generate the background based on the text prompt using a generative machine learning model. In some embodiments, the background generation process can be image-conditioned, aiming for consistency with other images from the merchant to match a specific theme or aesthetic, thereby creating a cohesive look and feel across multiple images.

The candidate image selection module 208D may comprise code or software, executable by the processor 204, for selecting an image of a plurality of candidate images. The candidate image selection module 208D, in conjunction with the processor 204, can obtain a plurality of candidate images of items. The candidate image selection module 208D, in conjunction with the processor 204, can perform a duplicate image removal process (e.g., deduplication) to detect and remove any redundant images from the plurality of candidate images.

After removing duplicates, the candidate image selection module 208D, in conjunction with the processor 204, can perform a comparative ranking of the remaining candidate images. The ranking can be based on a plurality of factors, including aesthetic appeal, realism, and the appetizing appearance of the food item depicted in the image. The ranking process can also factor in other signals, such as encouraging diversity among the selected images and ensuring that the images are consistent with a service provider's requests and/or branding. The candidate image selection module 208D, in conjunction with the processor 204, can then select the top-ranked image as the final selected candidate image to be outputted.

The network interface 206 may include an interface that can allow the image analysis computer 108 to communicate with external computers. The network interface 206 may enable the image analysis computer 108 to communicate data to and from another device (e.g., the image database 106, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

### III. Image Processing and Candidate Image Generation

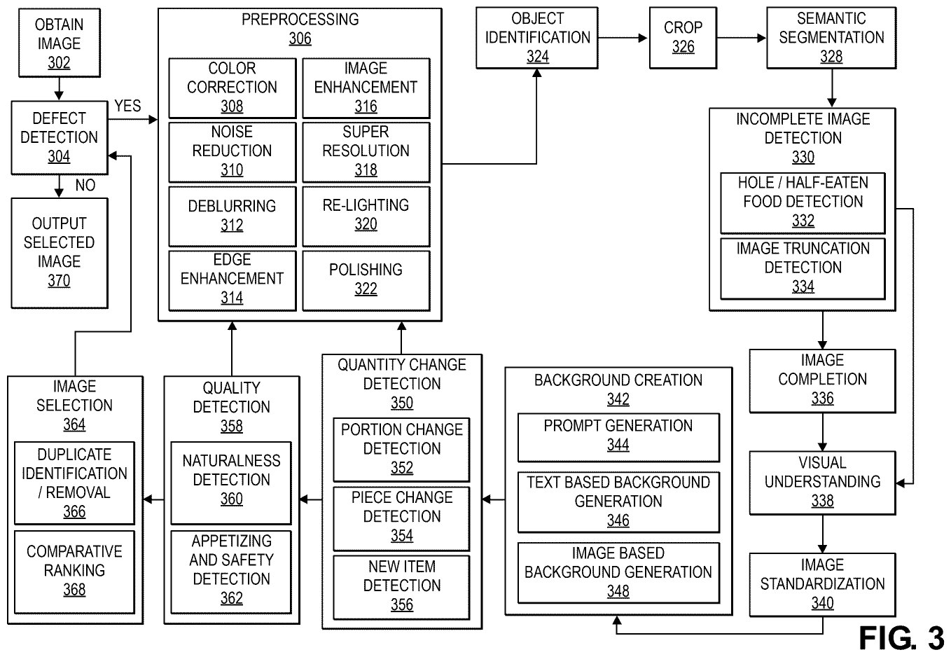

FIG. 3 shows a hybrid diagram illustrating an image processing method according to some embodiments. In some embodiments, the steps illustrated in FIG. 3 may or may not be performed based on the image (e.g., based on the quality and/or features of the image). Each step illustrated in FIG. 3 can be performed one or more times on the image using the same non-deterministic process or a different method of performing the process. As such, at each step, the computer can accept an image as input and can determine one or more output images. Each image can be propagated through the steps in the process. Near the end of the process (e.g., at step 378) there may be a plurality of candidate images from which a selected image can be selected.

### A. Image Acquisition

At step 302, a computer (e.g., an image analysis computer) can obtain an image that includes an item. The computer can obtain the image from an image database. The image can be a user-generated image, for example, an image captured by an end user or a transporter associated with a delivery service. The image may exhibit one or more quality defects. For example, the image can suffer from poor lighting, blurriness, or an unappealing presentation of the item, such as a food item being depicted in a takeout container with other distracting objects in the background.

The image may have been previously stored in the image database by a central server computer. For example, the central server computer can receive the image from a user device. The image may be an user generated image that is submitted to the computer via a public URL.

### B. Defect Detection

At step 304, after obtaining the image, the computer can perform a defect detection process. The computer can determine whether or not the image has at least one defect that may affect its suitability for use in a menu, in an application, or on a website. Defects can include, for example, bites taken out of the food item, portions of the food being cut off at the edge of the image, excessive blurriness, poor lighting, occlusion by foreign objects, the presence of distracting background elements, or other visual anomalies that degrade the quality or authenticity of the image. The computer can implement one or more computational techniques, including both rule-based image analysis and machine learning models, to identify such defects.

For example, a machine learning model can be trained to recognize typical shapes and contours of various food items and can identify anomalies, such as unnatural indentations, that would indicate a bite has been taken. As one example, a defect detection machine learning model can be trained to recognize typical shapes and contours of various food items using a large annotated dataset of high-quality food images. The defect detection machine learning model can identify anomalies, such as unnatural indentations, irregular edges, or missing sections, that would indicate a bite has been taken or a portion has been removed. For example, the defect detection machine learning model can be a convolutional neural network or a vision transformer model that can analyze the outline of the segmented food and detect deviations from expected geometric profiles for specific food types.

As another example, a machine learning model can analyze a segmentation mask of a food item to determine if a significant portion of the item's boundary aligns with the edge of the image frame, which can indicate that the item has been truncated or improperly cropped in the original image. The segmentation mask can be a digital, pixel-level map of the image that identifies and isolates specific objects or regions of interest. The segmentation mask can be generated by a semantic segmentation process, as described in further detail below. In some embodiments, the segmentation mask can be a precise digital stencil that is the same size as the original image, with each pixel classified as belonging to the food item or the background. The computer can then quantify how many boundary pixels of the mask coincide with the image border and, if this proportion exceeds a defined threshold, classify the image as defective due to truncation.

In addition to shape and boundary analysis, the computer can use further techniques for defect detection. For example, the computer can apply a blur detection algorithm, such as a variance of the Laplacian method, to measure image sharpness and flag images with excessive blurring. The computer can analyze the histogram of pixel intensities to detect poor lighting or underexposure. The computer may also utilize object detection models, such as YOLO or MaskRCNN, to identify and flag the presence of hands, utensils, or foreign objects occluding the food item, as well as to detect if the food item is not sufficiently centered or occupies too small a portion of the image.

The computer can also deep learning models trained for image quality assessment, which can score the overall visual quality of the image and identify those that fall below an acceptable threshold. In some embodiments, the computer can use ensemble methods that combine outputs from multiple specialized defect detectors to increase robustness and accuracy.

If the image includes no defects, then the image can be output as a selected image, at step 370. If the image includes a defect, then the computer can proceed to step 306 to begin improving the image.

### C. Image Preprocessing

At step 306, after determining that the image includes a defect, the computer can preprocess the image. This step can involve running various image processing and computational photography techniques to improve the image quality. For example, the computer can perform any combination of steps 308-322 to preprocess the image.

At step 308, the computer can perform color correction. During this step, the computer can adjust the color balance, brightness, contrast, and saturation of the image to correct for suboptimal lighting conditions present during the original image capture, thereby ensuring that the colors of the food item appear more natural, vibrant, and appetizing. An exemplary technique for this can be histogram equalization, where the computer redistributes the pixel intensity values to more effectively utilize the entire brightness range, which can enhance the global contrast of the image.

At step 310, the computer can perform noise reduction. The computer can apply one or more algorithms to identify and remove unwanted visual artifacts, often referred to as digital noise, which can manifest as graininess or random speckles in the image, to produce a cleaner and smoother final image. For example, the computer can apply a median filter, which can be effective at removing salt-and-pepper noise by replacing each pixel's value with the median value of the neighboring pixels.

At step 312, the computer can perform deblurring. The computer can analyze the image to detect and reduce blurriness that may have been caused by camera shake, motion of the subject, or improper focus, thereby improving the overall clarity and definition of the food item. For example, a specific technique can involve using a Wiener deconvolution filter, which can be an algorithm that attempts to reverse the distortion by estimating the point spread function that caused the blur.

At step 314, the computer can perform edge enhancement. This can involve applying image processing filters to accentuate the edges and boundaries within the image, particularly around the food item, making the item appear more defined and distinct from its background. An example of a technique for edge enhancement can be the application of an unsharp mask, where a blurred version of the image can be subtracted from the original image to create a mask of the edges, which can then be added back to the original to increase local contrast along those edges.

At step 316, the computer can perform image enhancement. The computer can apply a combination of computational photography techniques to improve the overall aesthetic quality of the image, which can include adjusting the tonal range and improving local contrast to make the food item appear more appealing. A technique for this can be contrast limited adaptive histogram equalization (CLAHE), which can enhance contrast locally by computing several histograms, each corresponding to a distinct section of the image, and using them to redistribute the lightness values of the image.

At step 318, the computer can perform super resolution. The computer can utilize a machine learning model, such as a deep neural network, to increase the effective resolution of the image, generating additional detail that may not have been present in the original low-resolution image. For example, the computer can employ a super-resolution generative adversarial network (SRGAN), which can be trained to generate photorealistic high-resolution images from lower-resolution inputs.

At step 320, the computer can perform re-lighting. The computer can digitally modify the lighting characteristics within the image to create a more professional and aesthetically pleasing effect, which can include simulating different light sources and adjusting the direction and intensity of shadows and highlights. As an example, this may be achieved by using a neural network model trained to predict surface normals and albedo from a single image, which may then be used as inputs to a rendering engine to realistically apply new virtual lighting effects to the item.

At step 322, the computer can perform polishing. The computer can perform a final set of adjustments to give the image a finished, high-quality appearance, which can include subtle modifications to color, texture, and overall composition to ensure the image meets the quality standards for a menu photograph. An exemplary polishing technique can be the application of a color look-up table (LUT), which can be a predefined matrix used to transform the color space of the image to achieve a specific, consistent stylistic look or color grade.

### D. Object Identification and Item Image Creation

At step 324, after preprocessing the image, the computer can perform an object identification process. The object identification process can include object detection and classification. For example, the computer can analyze the pixel data of the image using a trained machine learning model to detect the presence and location of one or more objects within the image. Once an object is detected, the computer can further classify the object by assigning it a specific label, for instance, identifying it as a particular type of food.

Object detection and classification techniques can include MaskRCNN, YOLO, EVA, etc. These examples of computer vision systems can be trained on large datasets to recognize and categorize a wide variety of objects with a high degree of accuracy. The computer can leverage one or more of these systems to efficiently process the image and identify relevant items contained therein.

For example, the computer can identify at least a food item in the image. By utilizing a model trained specifically on a corpus of food imagery, the computer can draw a bounding box around the food item and assign it a corresponding class label, such as “sushi,” “salad,” or “steak,” distinguishing it from other non-food elements in the image.

In some embodiments the object identification process may only need to be utilized when an item has more than one object in the image (e.g., has two food items in the image).

At step 326, after identifying the item in the image, the computer can crop the image to obtain an item image (e.g., a food item image). For example, the computer can separate at least the food item from the image to form a food item image. The computer can crop at least the food item image from the image to separate the food item from any additional elements including a plate or container.

As an illustrative example, the computer can use the coordinates of the bounding box generated during the object identification step to define the boundaries for a crop operation, thereby isolating the portion of the image that contains the identified food item and discarding the surrounding background.

At step 328, after obtaining the item image, the computer can perform a semantic segmentation process. Semantic segmentation can be a process that involves assigning a class label to each individual pixel in an image, which can allow for a highly precise, pixel-level delineation of objects. The semantic segmentation process can involve segmenting out the food, but excluding other aspects of the photo such as the plate, body parts holding up the food, etc. In some embodiments, the computer can utilize an API call to perform semantic segmentation with Claid and/or Photoroom's APIs, or with any of several off-the-shelf, open-source solutions such as SwinTransformers.

### E. Incomplete Item Image Detection

At step 330, after obtaining the item image of an item in the image, the computer can determine whether or not the item image is incomplete. For example, the computer can determine whether or not the food item image includes an incomplete food item.

The computer can perform an incomplete image detection process. For example, the computer can perform a hole/half-eaten food detection process at step 332 and/or an image truncation detection process at step 334.

At step 332, the computer can determine whether or not there is a hole and/or a half-eaten food portion in the image. The computer can utilize a machine learning model to determine whether or not there is a hole and/or a half-eaten food portion in the image.

As an illustrative example, in some embodiments, the computer can utilize a machine learning model configured as a binary classifier that has been trained on a large dataset of food images labeled as either “complete” or “incomplete.” This model can analyze the extracted features of the food item, such as its texture, shape, and internal patterns, to identify characteristics indicative of a missing portion, like the irregular edge of a bite mark or a clean cut from a utensil. In other embodiments, an anomaly detection approach can be used, where a model can be trained on images of complete food items. When an image of an incomplete item is provided as input, the model's inability to accurately reconstruct the anomalous regions can result in a high reconstruction error, which can be used as a signal to classify the item as incomplete.

At step 334, the computer can determine whether or not the item image is truncated. The computer can utilize a truncation detection process to determine whether or not the item image is truncated. Truncation detection can include an image processing task in which the computer can evaluate whether or not a segmentation mask, obtained from the object identification step, is cut off at the edge of the image.

As an illustrative example, the computer can apply a contour detection algorithm to the segmentation mask (e.g., binary segmentation mask) of the food item to precisely identify its boundary pixels. The computer can then iterate through the coordinates of these boundary pixels and compare them against the dimensions of the image frame. A counter can tally the number of boundary pixels that lie on the image edge. If this count exceeds a predefined threshold or represents a significant percentage of the total contour length, the computer can determine that the item is truncated. To further refine this detection, in some embodiments, the computer can analyze the geometric properties of the contour at the image boundary; an unnaturally straight line segment that aligns perfectly with the image edge can provide a strong indication of truncation, as opposed to a natural, curved boundary that merely touches the edge at a single point.

If the item image is incomplete, then the computer can proceed to step 336. If the item is complete, then the computer can proceed to step 338.

### F. Item Image Modification

At step 336, the computer can modify the item image if the item image is determined to be incomplete. The computer can modify the item image using an image completion process. The computer can perform an image completion process utilizing techniques such as in-filling and/or out-filling to complete missing items, so that the item can be zoomed out and centered in an overall image without an artifact appearing because the food got cut-off where the edge of the image was.

The computer can perform in-filling. In-filling can be a technique where the computer synthesizes new pixel data to fill in missing or damaged regions within the interior of an object in the image. This process, also referred to as inpainting, can be useful for repairing images of food items that appear to be partially eaten or have other internal portions removed. The computer can utilize a generative model, such as a generative adversarial network (GAN) or a diffusion model such as stable diffusion, which can analyze the texture, color, and structural patterns of the pixels surrounding the missing area to generate new content that seamlessly and realistically completes the food item.

The computer can perform out-filling. Out-filling can be a technique where the computer extends the image beyond its original canvas, generating new content that is contextually consistent with the existing image. This process, also referred to as out-painting, can be applied when a food item has been truncated at the edge of the image frame. To accomplish this, the computer can utilize an image generation model to generate images and/or image portions. For example, in some embodiments, the image generation model can include a stable diffusion architecture. The image generation model can be provided with the existing image and a mask indicating the area to be extended. The image generation model can then generate the missing portions of the food item in a manner that logically continues its shape, color, and texture. In some embodiments, the computer can utilize API calls to existing models to perform in-painting and out-painting. For example, an API with Claid can utilize an “outpaint” option to generate an image and/or an image portion.

As such, the computer can determine whether or not the food item image includes an incomplete food item. The computer can then modify the food item image to complete the incomplete food item in the food item image using an in-filling process and/or an out-filling process.

### G. Visual Understanding Process

At step 338, after obtaining a complete item image, the computer can perform a visual understanding process to generate a semantic interpretation of the item image. This process can involve analyzing various properties related to the food item in the image, and this information can be used to inform subsequent processing steps, particularly the generation of a new background.

The visual understanding process can be flexibly integrated into the workflow. For example, in some embodiments, the visual understanding process can be executed at different stages, such as before semantic segmentation or after image completion, and the outputs from these different sequences can be used to generate a plurality of candidate images for the computer to later select between at step 364.

The visual understanding process can include the computer making several determinations to bias the background creation step. For example, the computer can analyze the geometric features of the food item to determine the optimal shape of a serving utensil that would best complement the item, such as a round bowl for soup or a rectangular plate for sushi. The computer can also identify the color characteristics of the original take-out container and utilize this information to select a color for the new container or background that harmonizes with the food item. Furthermore, the computer can assess the contextual cues and semantic details in the image to determine the most suitable type of serving utensil for the food, such as classifying whether the item would be best presented in a bowl, on a plate, or in a cup or glass.

As an illustrative example, the item image can be an image depicting noodles. The computer can determine, through visual understanding, that the item image represents a dish whose optimal presentation can be in a round ceramic bowl, with a background color or texture that complements the color and shape of the noodles. The computer can further analyze the visual context to infer that the best utensil may be chopsticks, and the background bias to include a wooden table surface that aligns with the aesthetic of the cuisine.

To perform this analysis, the computer can utilize multimodal large language model(s). In some embodiments, the computer can utilize a third-party system or API that is capable of understanding and reasoning over image content. In other embodiments, the computer can employ a visual question answering (VQA) system. The VQA system can, for example, be built upon a vision transformer architecture such as BEiT (bidirectional encoder representation from image transformers), to programmatically answer specific questions about the properties of the food item in the image.

For example, the computer can generate a prompt that includes the item image as well as accompanying text that instructs a multimodal large language model to generate descriptive text relating to the visual characteristics of the item image. The prompt can request the multimodal large language model to analyze features such as colors, textures, shapes, containers, potential background types, and suitable utensils for the depicted food item. The computer can input this prompt into the multimodal large language model, which can process both the visual and textual elements of the prompt and generate an output that includes detailed text describing the visual properties of the item image.

As an illustrative example, for an item image depicting noodles, the multimodal large language model can output text such as: “main color: tan, texture: smooth and slightly glossy with irregular strands, shape: elongated and intertwined, container: round ceramic bowl with a light blue rim, potential background types: rustic wooden table or polished marble surface, suitable utensils: chopsticks or a ceramic soup spoon.” This descriptive output can be used to inform subsequent processing steps, such as background generation, to ensure that the final candidate image is visually coherent and contextually appropriate for the food item being depicted.

### H. Image Standardization

At step 340, after determining a visual understanding of the image, the computer can standardize the item image. This step involves using the segmentation map to make the photo of the food look more “standardized,” but applying various image processing operations such as rotation, centering and zooming, to ensure that all photographs have a consistent feel (for example, with the food appearing in the center of the photo and occupying a certain portion of the photo in a way that makes the food in the photograph simultaneously look clear and aesthetically pleasing). Some heuristics here include: 1) if an image is cutoff at one side, rotating the image to make it so that the cutoff edge is at the top improve look and feel and 2) sometimes, there are images that were taken vertically rather than horizontally.

This standardization process can involve applying a series of image processing operations, such as rotation, centering, and zooming. These operations can be designed to ensure that all photographs processed by the system exhibit a consistent and aesthetically pleasing appearance, with the food item prominently and centrally displayed within the image frame.

For example, the computer can analyze the spatial distribution of the food item within a larger image and adjust its orientation to improve visual balance. The computer can identify whether the image was originally captured in a vertical or horizontal orientation and apply appropriate transformations to achieve uniformity across different images. The centering and zooming operations can be configured to position the food item in the center of the frame and scale it to occupy a predetermined proportion of the image, thereby maximizing clarity and ensuring that the food item remains the focal point. By applying these heuristics and adjustments, the standardization process can produce final images that are visually coherent, professionally composed, and suitable for display on a menu or service provider website.

### I. Background Generation

At step 342, after standardizing the item image, the computer can generate a background for the item image. This process, often referred to as “plating” the food, can involve synthesizing a visually appealing background that complements and appropriately presents the food item. The background generation can be accomplished through a sequence of steps, including prompt generation, text-guided background creation, and conditional image synthesis, as detailed in steps 344-348. Step 346 and step 348 describe two different methods for generating a background. The computer can perform both steps to generate two different backgrounds, which can be parallel processed through the subsequent steps to create multiple candidate images to select from for inclusion into the menu, delivery application, website, etc.

At step 344, the computer can use a large language model to generate one or more textual background prompts. The textual background prompts can be utilized to prompt a generative machine learning model that generates images for the background of the item image.

The computer can aggregate contextual and descriptive information relevant to the food item and its intended presentation. For example, the computer can collect details such as the name and description of the dish, the “About” section of the associated service provider (e.g., restaurant), and any relevant branding or thematic information associated with the service provider. The computer can also utilize the previously determined visual understanding of the item image.

The computer can provide the aforementioned data to the large language model. The large language model can evaluate the provided data and can generate one or more textual background prompts for background generation. The textual background prompt can include text that describes a request for a particular background to be generated that would fit with the item image. For example, the textural background prompt may specify a request for a rustic wooden table background, a specific color palette, or a particular style of serving dish that harmonizes with the food item.

At step 346, the computer can perform text-based background generation using the textual background prompt. The computer can utilize the textual background prompt to initiate an image creation process, where the background for the segmented food item is generated in accordance with the specifications outlined in the textual background prompt. The computer can utilize generative models, such as diffusion-based architectures, to produce realistic and aesthetically pleasing backgrounds that align with the service provider's desired presentation.

At step 348, the computer can perform image-based background generation. In this process, the computer can use both the segmented food item image and the textual background prompt to synthesize a background that not only matches the specifications given in the prompt but also maintains visual consistency with the food item's appearance and presentation style. The image-based background generation can involve providing the generative model with the actual item image and item image features, such as color, texture, and spatial arrangement, to ensure that the background and the food item are seamlessly integrated.

In some embodiments, the image-based background generation can utilize additional images for other items that are provided by the same service provider. This can aid the image generation model in generating a background that is cohesive with other images that are associated with the service provider. As such, the image-based background generation process can provide consistency with other images presented on the service provider's page. The computer can analyze additional images from the merchant's menu or branding materials to extract thematic elements, such as a specific color scheme, style of plating, or visual motif. The background generation process can then be conditioned on both the textual background prompt and the visual features of these reference images, ensuring that all generated plating backgrounds look similar and contribute to an impressively consistent look-and-feel across the merchant's offerings. This approach enables the system to produce menu images that are visually coherent, professionally styled, and aligned with the overall aesthetic of the service provider.

The computer can create a candidate image by creating a background for the food item image and then applying the background to the food item image. The candidate image can include both the item image and the background.

### J. Modified Item Image Quantity Evaluation

At step 350, the computer can determine whether or not quantities in the candidate image have been changed from the original item image. The computer can identify whether or not the candidate image misrepresents certain aspects of the original image, specifically with respect to the amount or portion of food depicted. The computer can identify when there is a change in the quantity of food shown in the image that might misrepresent the service provider's intended portions. Such misrepresentation can occur when the background is modified, for example, through the addition of garnishes or sauces, or as a result of in-filling or out-filling operations. The computer can conduct several sub-tasks (e.g., steps 352-356) to assess the integrity and authenticity of the modified image, including portion change detection, piece change detection, and new item detection.

For example, the computer can perform a quantity validation process. The quantity validation process can comprise at least one of: 1) a portion change detection process that compares a first segmentation mask of the food item in the candidate image to a second segmentation mask of the food item in the image, 2) a piece change detection process that counts a number of discrete pieces of the food item, and 3) a new item detection process that identifies garnishes or other food items not present in the image.

At step 352, the computer can determine whether or not the portions (e.g., size) of the item (e.g., food) have changed as depicted in the candidate image. The computer can analyze the segmentation mask of the food item in both the original image and the candidate image to quantify the area occupied by the food item. By comparing the percentage of the mask area between the two images, the computer can detect significant changes in the portion or size of uncountable food items, such as guacamole, soup, rice, curry, or beans. For example, the computer can calculate the ratio of the mask area in the candidate image to the mask area in the original image. If this ratio exceeds a predetermined threshold, the computer can indicate that the quantity has changed beyond acceptable limits, potentially due to in-filling or out-filling operations. In some embodiments, minor adjustments may be permissible, especially when correcting edge artifacts from oddly shaped containers or images where the food was previously truncated.

At step 354, the computer can determine whether or not the number of pieces of the item has changed. For food items that are countable and expected to have a specific number of pieces (e.g., maki rolls, tortillas, or chicken wings), the computer can perform a piece-change detection process. This process can involve using a visual question answering system or a dedicated object counting model, such as YOLO or MaskRCNN with counting capabilities, to enumerate the discrete pieces in both the original image and the candidate image. The computer can then compare the counts to ensure that in-filling, out-filling, or plate creation has not inadvertently introduced additional pieces or removed any from the original image. The computer can aim to maintain an accurate representation of the original portion and prevent misrepresentation of the service provider's offering.

A variant of the system could also use the item names and descriptions to ensure count consistency. For example, the item may be called “Chicken Wings (8 pieces)”, or “8 pieces” may be a part of the description of the item. In this case, it is possible to use the item name and/or description as an additional validation mechanism to ensure that the correct number of pieces are present

At step 356, the computer can determine whether or not a new item has been added to the image. The computer can perform new item detection by comparing the original image and candidate image using object detection and classification models. For example, the computer can utilize a system like MaskRCNN, YOLO, or a VQA model to identify and classify all objects present in both images. The computer can also use comparative image analysis techniques, such as multimodal large language models (e.g., GPT-4o or Llama 3), with both images provided as input, to identify any new items (e.g., garnishes, sauces, or entirely new food elements) that have been added during the image modification process.

If the computer determines that the portions have been changed, the piece count has changed, and/or new items have been added, then the computer can terminate the processing of the candidate image and proceed to step 306 to re-start the image improvement process.

### K. Modified Item Image Quality Evaluation

At step 358, the computer can evaluate the quality of the modified item image. The computer can determine whether or not qualities in the candidate image have been changed from the original item image. The computer can identify whether or not the candidate image misrepresents certain aspects of the original image, specifically with respect to the naturalness or appetizing-ness depicted. The evaluation process can involve detecting changes that might affect the perceived authenticity and desirability of the food item, such as unnatural visual artifacts, unrealistic placement, or unappealing presentation. The computer can identify when there is a change in the quality of food shown in the image that might misrepresent the service provider's intent. Such misrepresentation can occur when the background is modified, for example, through the addition of elements that do not align visually with the food item, inconsistent shadowing, or the introduction of colors and textures that clash with the original image. The computer can conduct several sub-tasks (e.g., steps 360-362) to assess the integrity and authenticity of the modified image, including naturalness detection and appetizing and safety detection, to assess the integrity and authenticity of the modified image.

For example, the computer can perform a quality validation process. The quality validation process can include at least one of: 1) a naturalness detection process to identify visual artifacts, where the visual artifacts include inconsistent lighting or unnatural placement of the food item relative to the background, and 2) an appetizing-ness detection process to evaluate a visual appeal of the food item.

At step 360, the computer can perform naturalness detection. The computer can analyze the candidate image to determine whether or not the visual composition conforms to realistic expectations for food presentation. This analysis can involve evaluating the spatial relationship between the food item and its background, inspecting for unnatural effects such as the food appearing to float above the plate, or identifying oddities in the edges of the food item, such as sharp or jagged boundaries that do not occur naturally. The computer can also assess the consistency of shadows and reflections, verifying that the lighting in the image is uniform and plausible for the depicted scene. To accomplish this, the computer can utilize advanced machine learning models, such as a visual question answering system or a multimodal large language model (e.g., GPT-4o). In some embodiments, the computer can utilize a machine learning classifier model that is trained on a dataset of menu-quality images to automatically detect unnatural placements and visual inconsistencies. The classifier model can be based on convolutional neural networks (CNNs), vision transformers, or hybrid architectures specifically tuned for food photography realism.

For example, the computer can input the candidate image along with a text prompt that includes information relating to naturalness detection into a multimodal large language model. The multimodal large language model can process the candidate image and the text prompt to determine whether or not the candidate image appears to be natural. The multimodal large language model can output a response that includes a classification of the candidate image as being “natural” or “unnatural,” or includes a naturalness value that indicates how natural the candidate image looks on a scale (e.g., 0-100).

As an illustrative example, the text prompt can be “Evaluate the image for visual realism. Does the food item appear naturally placed on the plate? Are the edges smooth and consistent with typical food photography? Are the shadows and lighting plausible for a professional menu image? Output a score from 0 to 100 indicating the degree of naturalness and specify whether any unnatural artifacts are present.” The multimodal large language model can provide both a numeric score and qualitative feedback as output, such as “The food appears slightly elevated above the plate; shadows are inconsistent; naturalness score: 45/100.”

At step 362, the computer can perform appetizing-ness and safety detection. The computer can determine whether or not the candidate image portrays the food item in an appetizing and desirable manner. This process can include evaluating the color, texture, and presentation of the food to ensure it is visually appealing and likely to encourage positive response. Furthermore, the computer can conduct a safety assessment to detect potential issues, such as the food being placed directly on a table without a plate or utensil, which might be considered unsanitary or unprofessional. The computer can utilize machine learning model(s), such as convolutional neural networks trained for food presentation quality, VQA systems to identify specific risks or unappetizing features in the image, or multimodal large language models to evaluate the candidate image and a text prompt requesting the evaluation.

For example, the computer can input the candidate image along with a text prompt that includes information relating to appetizing-ness and safety detection into a multimodal large language model. The multimodal large language model can process the candidate image and the text prompt to determine whether or not the candidate image appears to be appetizing and/or safe. The multimodal large language model can output a response that includes a classification of the candidate image as being “appetizing” or “unappetizing,” or includes an appetizing-ness value that indicates how appetizing the candidate image looks on a scale (e.g., 0-100).

As an illustrative example, the text prompt can be “Assess the image for food appeal and safety. Does the food look fresh and appetizing? Is the presentation clean, and is the food served in appropriate dishware? Are there any safety concerns, such as food placed directly on the table or missing utensils? Provide a score from 0 to 100 for appetizing-ness and flag any safety concerns with specific comments.” The multimodal large language model can provide both a numeric score and qualitative feedback as output, such as “The food appears fresh and brightly colored, served in a bowl; appetizing-ness score: 92/100; no safety concerns detected,” or “Food placed directly on table; appetizing-ness score: 22/100; safety concern: missing plate.”

### L. Image Selection

At step 364, the computer can select a candidate image from a plurality of candidate images. Throughout the previous steps in the process, many different variables can be altered to produce dozens or even hundreds of candidate images associated with the original image. For example, the computer can generate multiple candidates by applying different sets of pre-processing parameters, utilizing various prompts generated by the large language model for background creation, employing different generative APIs or models (e.g., Claid versus Photoroom), or using different random seeds during diffusion process(es) for background synthesis. This combinatorial approach can result in a large and diverse pool of candidate images from which the optimal candidate image can be selected.

At step 366, the computer can identify duplicate candidate images in the plurality of candidate images. The computer can identify duplicate candidate images by determining how closely two images match one another. An image may match another image if the perceptual content is nearly identical (e.g., as determined by a threshold value), even if the underlying pixel data is not exactly the same. In some embodiments, the computer can determine a matching score that can indicate an amount of similarity between two candidate image.

The computer can determine the matching score, for example, using a machine learning model such as a Siamese neural network (e.g., a twin neural network), a pre-trained convolutional neural network for feature extraction, and/or other machine learning based process. For example, the computer can pass two images through a pre-trained convolutional neural network to extract high-dimensional feature vectors that represent the semantic content of each image. The computer can then calculate the cosine similarity between these two vectors to produce a matching score, where a score close to 1.0 indicates a high degree of similarity.

After identifying duplicate candidate images, the computer can remove the duplicate candidate images from the plurality of candidate images. The computer can perform a deduplication process to remove duplicate candidate images. For example, the computer can remove duplicate candidate images if they match another candidate image with a matching score over a predetermined threshold. For example, if the cosine similarity score between the feature vectors of two candidate images exceeds a threshold of 0.99, the computer can flag one of the images as a duplicate and remove it from the plurality of candidate images before the ranking process.

At step 368, the computer can rank the candidate images of the plurality of candidate images. The computer can rank the candidate images based on a weighted combination of one or more criteria, including the naturalness score, the appetizing-ness score, aesthetic appeal, realism, and consistency with the service provider's branding and theme.

The computer can rank the candidate images using an image ranker. The image ranker can be a machine learning model. For example, the image ranker can include a regression model (e.g., a gradient boosting regression model such as LightGBM and XGBoost) trained to predict a final quality score for each image. The input features for this machine learning model can include the outputs from the previous quality evaluation steps (e.g., the naturalness and appetizing-ness scores), as well as other quantitative image metrics such as sharpness, color diversity, and compositional balance.

The image ranker can rank provided candidate images based on aesthetic appeal, realism, how appetizing the food presented in the image looks, etc. The image ranker may also factor in other aspects such as encouraging diversity and ensuring that the images are consistent with the service provider's theming.

As such, the computer can create a plurality of candidate images including the candidate image by creating different backgrounds for the food item image. The computer can then rank the plurality of candidate images based on at least one criterion to produce a ranked list of candidate images. The at least one criterion can include aesthetic appeal, realism, or consistency with a theme of a service provider associated with the service provider computer. The at least one criterion can also include a naturalness score indicating the plausibility of lighting and object placement, an appetizing-ness score evaluating the visual appeal of the food item, an authenticity score measuring the fidelity of the food item's portion and components relative to the original image, a diversity metric to encourage variety in plating styles across the ranked images, and/or other quantity or quality based criteria related to the image, the food item image, the service provider associated with the food item and/or end users that may obtain the food item.

In some embodiments, the computer can select a top candidate image of the plurality of candidate images. In such a case, the computer can provide a fully automated pipeline with no human intervention needed.

In some embodiments, the computer can fine-tune and/or further train the image ranker. For example, the computer can randomly select some example candidate images to grade (e.g., score), which can be utilized as additional training data for the image ranker.

In some embodiments, the computer can select one or more candidate images from the plurality of candidate images. For example, one or more candidate images may have a ranking score (or other metric) that is above a ranking score threshold. The computer can select the one or more candidate images for use. For example, the one or more selected candidate images can all be displayed in a delivery application in association with an item that is depicted in the original image.

### M. Output Images

At step 370, after selecting the one or more candidate images, the computer can output the selected candidate image(s). The computer can perform any suitable further processing using, with, or based on the selected candidate image(s).

In some embodiments, the computer can store the selected candidate image(s) in an item information database in association with the item depicted in the original image. For example, the computer can update the database record corresponding to a specific menu item, such as “Pad Thai,” for a particular service provider. The computer can replace the existing low-quality or placeholder image in the database with the newly generated, high-quality candidate image. This update can also involve setting a flag in the database to indicate that the item now has a “verified” or “menu-quality” image, which could then be automatically rendered on the service provider's menu page within a delivery application or website.

The computer can display the selected candidate image in an application or a website of a service provider computer. For example, the computer can update a digital menu associated with the service provider by associating the selected candidate image with the corresponding food item listing. Subsequently, when an end user accesses the service provider's menu through the application, such as a food delivery application installed on an end user device, the selected candidate image can be displayed alongside the name, description, and price of the food item. This can serve to fill a missing entry in the service provider's menu or replace a lower quality existing image, thereby providing a more visually appealing and authentic representation of the food item to end users.

In other embodiments, the computer can select 2, 3, 5, 10, etc. candidate images and can present the selected candidate images to a service provider, or other user, for selection for use a delivery application, menu, website, etc. For example, the computer can present the selected candidate images to a client device for selection. The computer can receive a user selected candidate image from the selected candidate images. The computer can include the user selected candidate image in the item information database.

In addition to the automatic validation processes described above, it is possible to have a human moderation step as well which reviews the images so generated. The human moderation step allows for providing fine-grained feedback, such as that the image looks unnatural, the background has artifacts, the food is still partially eaten or cropped (i.e., in-painted/out-filled incorrectly), etc., or a combination of these. In this case, it is possible to send the image through the pipeleine (or specific parts of the pipeline, as applicable), for a follow-up round of improvements.

### IV. EXEMPLARY IMAGE MODIFICATIONS

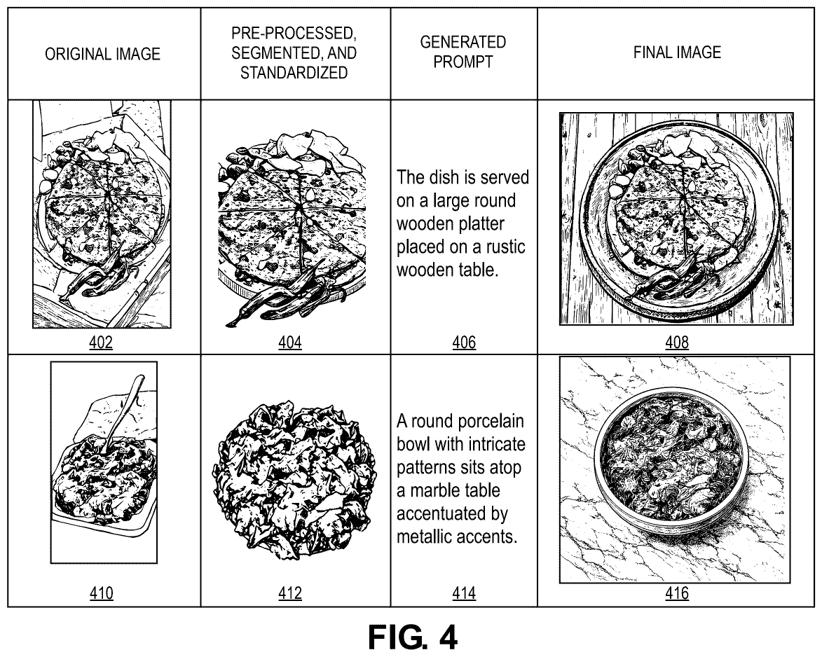

FIG. 4 shows a diagram illustrating exemplary modifications to images according to some embodiments. FIG. 4 illustrates two original images that have been modified to form two final selected candidate images. For each image, FIG. 4 depicts an original image, a pre-processed, segmented, and standardized image, a generated prompt, and a final image.

FIG. 4 includes a first original image 402. The first original image 402 includes a food item of quesadillas with garnishes and other food items along the side of the quesadillas. The food item is in a box container in the first original image 402.

The computer, as described herein, can pre-process the first original image 402, separate the food items from the first original image 402, and standardize the food item image. The computer can obtain the first food item image 404. Since the food item in the first original image 402 was truncated by the edge of the first original image 402, the edges of the first food item image 404 are missing and may be generated as described herein.

The computer can then generate a prompt using a large language model or other suitable process based on the first food item image 404 and/or other data relating to the food item, service provider, etc. The computer can generate a first prompt 406 that includes the text “the dish is served on a large round wooden platter placed on a rustic wooden table.”

The computer can then generate the first final image 408 using text conditioned background generation using at least the first prompt 406. The first final image 408 include the completed food item that was previously truncated in the first original image 402. The first final image 408 can also include the generated background that includes a wooden platter and a wooden table.

FIG. 4 includes a second original image 410. The second original image 410 includes a food item of a shawarma bowl. The food item includes a utensil (e.g., spoon) that is inserted into the food item. The food item is in a Styrofoam take out container.

The computer can pre-process the second original image 410, separate the food items from the second original image 410, and standardize the food item image. The computer can obtain the second food item image 412. Since the food item in the second original image 410 included a utensil, there can be a visual hole in the food item image where the utensil original was located. The computer can generate and fill-in the visual hole.

The computer can then generate a prompt using a large language model or other suitable process based on the second food item image 412 and/or other data relating to the food item, service provider, etc. The computer can generate a second prompt 414 that includes the text “a round porcelain bowl with intricate patterns sits atop a marble table accentuated by metallic accents.”

The computer can then generate the second final image 416 using text conditioned background generation using at least the second prompt 414. The first final image 408 include the completed food item that was previously missing a section due to the utensil in the second original image 410. The second final image 416 can also include the generated background that includes a porcelain bowl and a marble table.

### V. Item Fulfillment

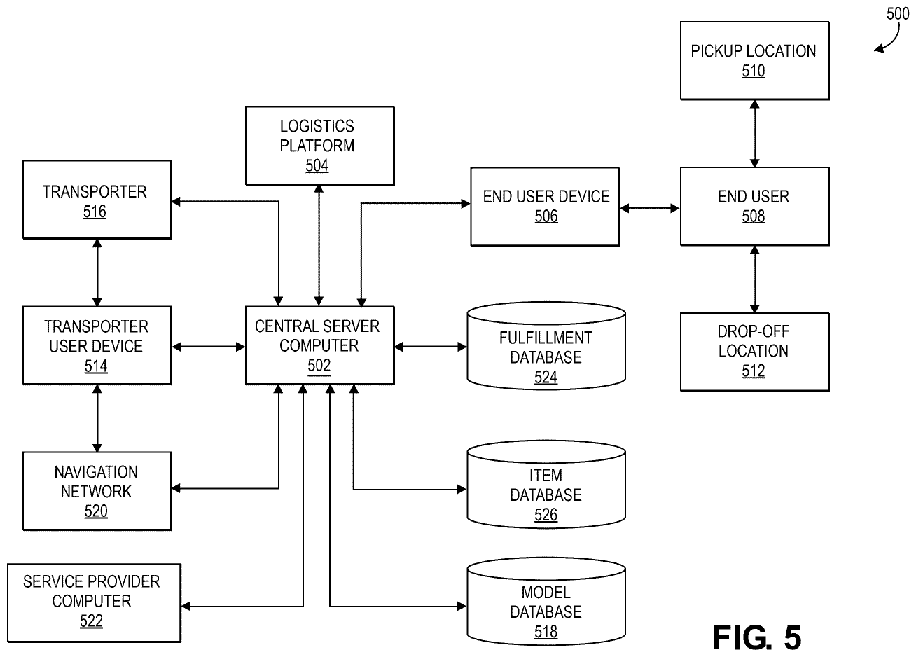

FIG. 5 shows a system 500 according to embodiments of the disclosure. The system of FIG. 5 includes a central server computer 502, a logistics platform 504, an end user device 506, an end user 508, a pickup location 510, a drop-off location 512, a transporter user device 514, a transporter 516, a model database 518, a navigation network 520, a service provider computer 522, a fulfillment database 524, and an item database 526.

The central server computer 502 can be in operative communication with the logistics platform 504, the end user device 506, the transporter user device 514, the navigation network 520, the service provider computer 522, the fulfillment database 524, and the model database 518, and the item database 526. The transporter user device 514 can be in operative communication with the navigation network 520.

For simplicity of illustration, a certain number of components are shown in FIG. 5. It is understood, however, that embodiments of the invention may include more than one of each component. In addition, some embodiments of the invention may include fewer than or greater than all of the components shown in FIG. 5. For example, although FIG. 5 shows one transporter, there can be two, three, or more transporters, transporter user devices, etc.

Messages between the devices and the computers in the system 500 in FIG. 5 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session. It is understood that other communication means can be utilized by devices in the system 500.

The central server computer 502 can include a server computer that can facilitate in the fulfillment of fulfillment requests received from the end user device 506. For example, the central server computer 502 can identify the transporter 516 (e.g., from among many candidate transporters) operating the transporter user device 514 as being suitable for satisfying the fulfillment request. The central server computer 502 can identify the transporter user device 514 that can satisfy the fulfillment request based on any suitable criteria (e.g., transporter location, service provider location, end user destination, end user location, transporter mode of transportation, etc.).

The central server computer 502 can receive data relating to a delivery order of items from the service provider computer 522 to the end user 508 at the drop-off location 512. The central server computer 502 can determine a route for delivery of the delivery order. The central server computer 502 can present the routes to a plurality of transporter user devices and/or transporters. The central server computer 502 can receive an acceptance (e.g., an acceptance message) from the transporter 516 that will deliver the items from the pickup location 510 to the drop-off location 512.

The logistics platform 504 can include a location determination system, which can determine the locations of various user devices such as the transporter user device 514 and the end user device 506. The logistics platform 504 can also include routing logic to efficiently route transporters using the transport user devices to various pickup locations that have the packages that are to be delivered to drop-off locations. Efficient routes can be determined based on the locations of the transporters, the locations of the pickup locations, the locations of the drop-off locations, as well as external data such as traffic patterns, the weather, etc. The logistics platform 504 can be part of the central server computer 502 or can be system that is separate from the central server computer 502.

The end user device 506 can include devices operated by the end user 508. The end user device 506 can generate and provide fulfillment request messages to the central server computer 502. The fulfillment request message can indicate that the request (e.g., a request for a service) can be fulfilled by one or more service provider computers (e.g., the service provider computer 522). For example, the fulfillment request message can be generated based on a cart selected at checkout during a transaction using a central server computer application installed on the end user device 506. The fulfillment request message can include one or more items from the selected cart.

The end user device 506 can provide a fulfillment request message to the central server computer 502 that indicates that the end user device 506 is requesting that the transporter 516 pick up an item from the pickup location 510 (e.g., a service provider of the service provider computer's location) and deliver the item to the drop-off location 512 (e.g., the end user's location).

The pickup location 510 can include locations in which items are stored. In the context of an inbound delivery to an end user, the pickup location can be a service provider location. In the context of an outbound delivery from an end user at an end user location, examples of the pickup location 510 may be a house or an apartment, a mailbox, a service provider location (e.g., a retail store, a grocery store, a dry cleaning store), a pickup hub, etc. Items can first be obtained from the pickup location 510 and then be transported to the drop-off location 512. Examples of the drop-off location 512 can be similar to the pickup location 510, such as a house or an apartment, a mailbox, a retail store, a grocery store, a dry cleaning store, a pickup hub, etc. In one example, a pickup location can be a pizza parlor from which an end user orders a pizza. A drop-off location can be an apartment in which the end user resides.

The transporter user device 514 can include a device operated by the transporter 516. The transporter user device 514 can include a smartphone, a wearable device, a personal assistant device, a laptop computer, etc. The transporter 516 can accept an end user's fulfillment request via an acceptance message. For example, the transporter user device 514 can be configured to generate and transmit a request to fulfil a particular end user's fulfillment request to the central server computer 502. The central server computer 502 can notify the transporter user device 514 of the fulfillment request. The transporter user device 514 can respond to the central server computer 502 with a request to perform the delivery to the end user device 506 as indicated by the fulfillment request.

In some embodiments, the transporter 516 can be an operator of a vehicle. In other embodiments, the transporter 516 can be a vehicle that can operated by an operator or can be autonomous. The vehicle can include a car, a truck, a van, a motorcycle, a bicycle, a drone, or other vehicle.

The navigation network 520 can provide navigational directions to the transporter user device 514. For example, the transporter user device 514 can obtain a location from the central server computer 502. The location can be a service provider parking location, a service provider location, an end user parking location, an end user location, etc. The navigation network 520 can provide navigational data to the location. For example, the navigation network 520 can be a global positioning system that provides location data to the transporter user device.

The service provider computer 522 can include computers operated by service providers. For example, the service provider computer 522 can be a food provider computer that is operated by a food provider. The service provider computer 522 can offer to provide services to the end user 508 of the end user device 506. In some embodiments, the service provider computer 522 can receive requests to prepare one or more items for delivery from the central server computer 502. The service provider computer 522 can initiate the preparation of the one or more items that are to be delivered to the end user 508 of the end user device 506 by the transporter 516 of the transporter user device 514.

The fulfillment database 524 can include any suitable database. The database may be a conventional, fault tolerant, relational, scalable, secure database such as those commercially available from Oracle™ or Sybase™. The fulfillment database 524 can store location data (e.g., a location that includes a latitude and longitude, etc.) and time data (e.g., a specific time).

The model database 518 can similarly be a conventional, fault tolerant, relational, scalable, secure database. The model database 518 can store machine learning models. The model database 518 can store machine learning models.

The item database 526 can similarly be a conventional, fault tolerant, relational, scalable, secure database. The item database 526 can store item data. The item database 526 can store item data for a plurality of items that are provided by service providers to end users via transporters. The item data can include item names, item descriptions, item images, item costs, item weights, item quantities, item categories, and/or any other data related to the creation of the item, the intrinsic properties of the item, and/or the process of providing the item to an end user.

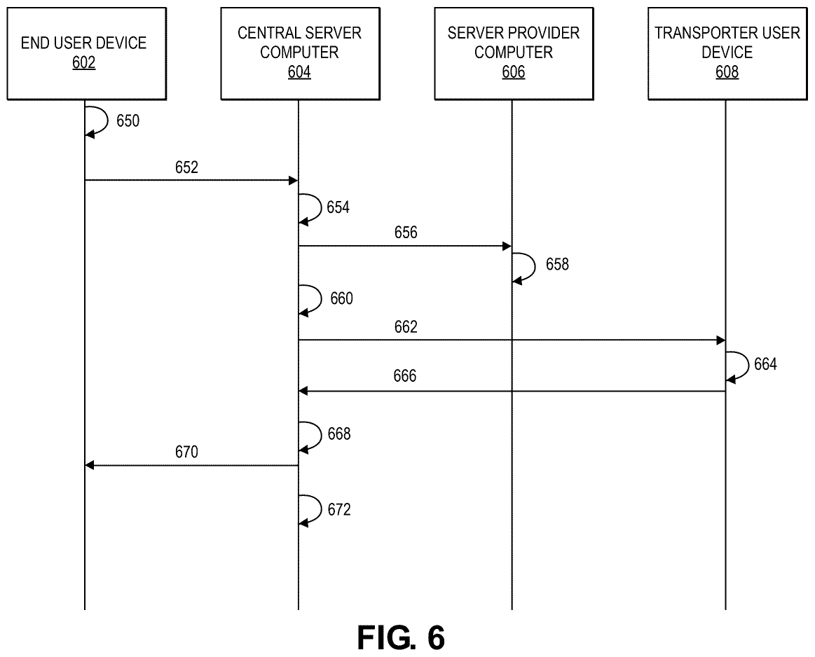

FIG. 6 shows a flow diagram illustrating a preparation and delivery method of an item according to embodiments. The method illustrated in FIG. 6 will be described in the context of the central server computer 502 receiving a fulfillment request message from the end user device 506 to fulfill preparation and delivery of one or more items from a cart to an end user of the end user device 506. The central server computer 502 can communicate with the service provider computer 522 and the transporter user device 514 to fulfill the fulfillment request.

At step 650, the end user device 506 can decide to check out with a cart in a central server computer delivery application installed on the end user device 506. The cart can include one or more items that are provided from a service provider of the service provider computer 522.

At step 652, after checking out with the cart, the end user device 506 can provide a fulfillment request message including the one or more items from the cart to the central server computer 502. The fulfillment request message can also include a service provider computer identifier that identifies the service provider computer 522.

At step 654, after receiving the fulfillment request message, the central server computer 502 can perform a transaction process with the end user device 506. For example, the central server computer 502 can communicate with a payment network to process the transaction for the one or more items. The central server computer 502 can receive an indication of whether or not the transaction is authorized. If the transaction is authorized, then the central server computer 502 can proceed with step 608.

At step 656, the central server computer 502 can provide the fulfillment request message, or a derivation thereof, to the service provider computer 522. The central server computer 502 can determine which service provider computer of a plurality of service provider computers to communicate with based on the service provider indicated in the fulfillment request message. For example, the fulfillment request message can indicate that the one or more items are provided by the service provider of the service provider computer 522. The central server computer 502 can identify the service provider computer 522 using the service provider computer identifier in the fulfillment request message.

At step 658, after receiving the fulfillment request message, the service provider computer 522 can initiate preparation of the one or more items. For example, the service provider computer 522 can alert service provider personnel (e.g., those preparing the items) at the service provider location. The service providers can prepare the one or more items for pick up by a transporter.

At step 660, after providing the fulfillment request message to the service provider computer 522, the central server computer 502 can determine one or more transporters operating one or more user devices that are capable of fulfilling the fulfillment request message. The central server computer 502 can determine the one or more transporters from the transporter user devices. The central server computer 502 can determine the one or more transporter user devices based on whether or not the transporter user device is online, whether or not the transporter user device 514 is already fulfilling a different fulfillment request message, a location of the transporter user device 514, etc.

At step 662, after determining the one or more transporter user devices, the central server computer 502 can provide the fulfillment request message, or a derivation thereof, to the one or more transporter user devices including the transporter user device 514.

At step 664, after receiving the fulfillment request message, the transporter of the transporter user device 514 can determine whether or not they want to perform the fulfillment. The transporter can decide that they want to perform the delivery of the one or more items from the service provider location to the end user location. The transporter user device 514 can generate an acceptance message that indicates that the fulfillment request is accepted.

At step 666, after generating the acceptance message, the transporter user device 514 can provide the acceptance message to the central server computer 502.

After providing the acceptance message to the central server computer 502, the transporter user device 514 can communicate with a navigation network and the transporter can proceed to the service provider location to obtain the one or more items. The transporter user device 514 can then receive input from the transporter that indicates that the transporter obtained the one or more items (e.g., the transporter selects that they picked up the items). The transporter user device 514 can then communicate with the navigation network and the transporter can then proceed to the end user location to provide the one or more items to the end user. In some embodiments, the transporter user device 514 can provide update messages to the central server computer 502 that includes a transporter user device 514 location and/or event data (e.g., items picked up, items delivered, etc.).

In some embodiments, after receiving the acceptance message, the central server computer 502 can notify the other transporter user devices that received the fulfillment request message that the fulfillment request is no longer available.

At step 668, at any point after receiving the acceptance message, the central server computer 502 can check the status of the fulfillment request. For example, the central server computer 502 can determine the location of the transporter user device 514 and can determine an estimated amount of time for the transporter user device 514 to arrive at the end user location.

At step 670, the central server computer 502 can provide an update message to the end user device 506 that includes data related to the fulfillment of the fulfillment request message. The data can include an estimated amount of time, the transporter user device location, event data (e.g., items picked up from the service provider), and/or other data related to the fulfillment of the fulfillment request message.

At step 672, the central server computer 502 can store any data received, sent, and/or processed during the fulfillment of the fulfillment request message into a database. For example, the central server computer 502 can store a user's cart selection as user features into a user feature database.

In some embodiments, the end user may search for a particular item using a search bar. In such cases, the central server computer 502 can use image filtering to surface contextualized images on the search feed that includes the item related to what an end user has searched. By providing the image related to what the user has searched, the user does not have to search through an entire menu to look for an item. For example, in FIG. 6, when a user searches for a “burger”, images related to the word “burger” for service providers are displayed in a screen.

In some embodiments, the plurality of images can be images of the plurality of service providers, and the inquiry request can be with respect to determining a service provider of the plurality of service providers. For example, an image can be an image of an item that can be provided by the service provider to the end user via the transporter.

For example, the central server computer can determine which service providers are displayed on the homepage. The homepage of the delivery application can have a plurality of “slots” that each can display a service provider. For each slot on the homepage, the central server computer can use a scoring algorithm to determine a service provider of the plurality of service providers to display in the delivery application.

### VI. ADVANTAGES

Embodiments of the invention provide a number of technical advantages to a technical problem associated with the field of computer vision and digital image processing. The invention provides a robust, end-to-end computational architecture that improves the functioning of the computer system itself by enabling it to transform unstructured, low-quality image data into high-quality, semantically coherent, and contextually appropriate visual representations. This provides a significant improvement over conventional methods that were unable to achieve this level of quality and accuracy through automated means. One technical advantage is the system's ability to transform unappealing, user-submitted photographs, which represent a challenging and inconsistent data input type, into appetizing, menu-quality images without requiring the computationally expensive and time-consuming process of professional photography.

Further, embodiments solve a specific technical problem of maintaining data integrity while performing generative image modifications. Unlike purely generative approaches, which are prone to fabricating details and misrepresenting content, the invention incorporates a multi-stage validation process that ensures the final image closely matches the actual dish in portion size, ingredients, and garnishes. The inclusion of computational modules for quantity change detection, piece change detection, and new item detection provides a concrete technical mechanism to overcome a known failure point in prior art generative systems. By programmatically analyzing and comparing segmentation masks and employing object counting models, the system improves the reliability and accuracy of the computer's output, ensuring the final image is not just aesthetically pleasing but also an authentic representation of the original item.

Furthermore, the technical solution provides for a new level of functionality. The architecture, which integrates semantic segmentation, visual understanding, conditional background generation, and hallucination detection, represents a significant improvement over merely applying these techniques in isolation. For instance, the visual understanding step provides critical semantic context that directly informs and constrains the conditional background generation, ensuring the resulting image is semantically coherent (e.g., placing soup in a bowl). This represents an improvement to the computer's ability to reason about and manipulate image data in a context-aware manner, a task that generic image editors are incapable of performing automatically.

Embodiments provide additional technical advantages related to the operational efficiency and scalability of the computer system. The highly automated nature of the multi-stage pipeline significantly reduces or eliminates the need for manual human intervention, which is a slow, subjective, and unscalable process. By providing a reliable, automated solution, the invention enables the computer system to process a high volume of images for thousands of merchants at a speed and consistency that would be impossible with human-in-the-loop systems. This improvement in processing throughput and efficiency is a direct enhancement of the computer's functionality for this specific technical application. The modular design of the architecture further enhances the system's technical capabilities by allowing different computational modules or APIs to be dynamically selected and swapped, enabling the system to be optimized for various trade-offs such as processing speed, computational cost, and output quality, thereby improving the overall adaptability and performance of the computer system.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a computer, image data for an image of a food item;
identifying, by the computer, at least the food item in the image;
separating, by the computer, at least the food item from the image to form a food item image;
modifying, by the computer, the food item image if the food item image is determined to be incomplete;
creating, by the computer, a candidate image by creating a background for the food item image and then applying the background to the food item image;
selecting, by the computer, the candidate image; and
displaying, by the computer, the selected candidate image in an application or a website of a service provider computer.

2. The method of claim 1, wherein separating at least the food item from the image comprises:
cropping, by the computer, at least the food item image from the image to separate the food item from any additional elements including a plate or container.

3. The method of claim 1, further comprising:
creating a plurality of candidate images including the candidate image by creating different backgrounds for the food item image; and
outputting the plurality of candidate images including the candidate image.

4. The method of claim 1, wherein the image data for the image is received from an end user device operated by an end user, wherein the end user device captures the image of the food item, wherein the food item is associated with a service provider of the service provider computer.

5. The method of claim 1, wherein modifying the food item image if the food item image is determined to be incomplete comprises:
determining, by the computer, whether or not the food item image includes an incomplete food item; and
if the food item is incomplete, modifying, by the computer, the food item image to complete the incomplete food item in the food item image using an in-filling process and/or an out-filling process.

6. The method of claim 5, wherein determining whether or not the food item image includes the incomplete food item comprises at least one of:
performing, by the computer, a truncation detection process by evaluating a segmentation mask of the food item at an edge of the food item image; and
performing, by the computer, a half-eaten food detection process using a machine learning model to identify anomalies in a shape of the food item.

7. The method of claim 1, wherein creating the background for the food item image comprises:
performing, by the computer, a visual understanding process on the food item image to determine at least one property of the food item image, wherein the at least one property includes a shape, a color, or an appropriate serving utensil;
generating, by the computer using a large language model, a textual prompt based on the at least one property; and
generating, by the computer, the background based on the textual prompt.

8. The method of claim 1, wherein the computer creates a plurality of candidate images, and wherein selecting the candidate image comprises:
selecting, by the computer, the candidate image from the plurality of candidate images.

9. The method of claim 1, wherein after creating the candidate image the method further comprises:
performing, by the computer, a quantity validation process to determine whether a quantity of the food item in the candidate image has changed relative to the image.

10. The method of claim 9, wherein the quantity validation process comprises at least one of:
a portion change detection process that compares a first segmentation mask of the food item in the candidate image to a second segmentation mask of the food item in the image,
a piece change detection process that counts a number of discrete pieces of the food item, and
a new item detection process that identifies garnishes or other food items not present in the image.

11. The computer of claim 1, wherein after creating the candidate image the method further comprises:
performing, by the computer, a quality validation process to determine whether a quality of the food item in the candidate image has changed relative to the image.

12. The computer of claim 11, wherein the quality validation process comprises at least one of:
a naturalness detection process to identify visual artifacts, wherein the visual artifacts include inconsistent lighting or unnatural placement of the food item relative to the background, and
an appetizing-ness detection process to evaluate a visual appeal of the food item.

13. The method of claim 1, further comprising:
preprocessing, by the computer, the image data for the image.

14. The method of claim 13, further comprising one or more of:
color correcting, by the computer, the image;
reducing, by the computer, noise in the image;
deblurring, by the computer, the image;
re-lighting, by the computer, the image; and
enhancing, by the computer, edges in the image.

15. A computer comprising:
a processor; and
a non-transitory computer readable medium comprising code, executable by the processor for performing a method comprising:
receiving image data for an image of a food item;
identifying at least the food item in the image;
separating at least the food item from the image to form a food item image;
modifying the food item image if the food item image is determined to be incomplete;
creating a candidate image by creating a background for the food item image and then applying the background to the food item image;
selecting the candidate image; and
displaying the selected candidate image in an application or a website of a service provider computer.

16. The computer of claim 14, wherein the method further comprises:
creating a plurality of candidate images including the candidate image by creating different backgrounds for the food item image; and
ranking the plurality of candidate images based on at least one criterion to produce a ranked list of candidate images.

17. The computer of claim 16, wherein the at least one criterion includes aesthetic appeal, realism, or consistency with a theme of a service provider associated with the service provider computer.

18. The computer of claim 16, wherein selecting the candidate image comprises:
selecting the candidate image from the ranked list of candidate images.

19. A system comprising:
an image database;
an item information database; and
an image analysis computer comprising:
a processor; and
a non-transitory computer readable medium comprising code, executable by the processor for performing a method comprising:
receiving image data for an image of a food item from the image database;
identifying at least the food item in the image;
separating at least the food item from the image to form a food item image;
modifying the food item image if the food item image is determined to be incomplete;
creating a candidate image by creating a background for the food item image and then applying the background to the food item image;
selecting the candidate image; and
displaying the selected candidate image in an application or a website of a service provider computer.

20. The system of claim 19, wherein the method further comprises:
storing the candidate image in the item information database.
